(19) United States
(12) Patent Application Publication
(10) Pub. No.: US 2025/0147893 A1
(43) Pub. Date: May 8, 2025

(54) CACHE EVICT DUPLICATION MANAGEMENT

(71) Applicant: Akeana, Inc., Santa Clara, CA (US)

(72) Inventor: Sanjay Patel, San Ramon, CA (US)

(73) Assignee: Akeana, Inc., Santa Clara, CA (US)

(21) Appl. No.: 18/937,091

(22) Filed: Nov. 5, 2024

Related U.S. Application Data
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/714,529, filed on Oct. 31, 2024.
(60) Provisional application No. 63/702,192, filed on Oct. 2, 2024.

(51) Int. Cl. G06F 12/0891; G06F 12/0817; G06F 13/16

(52) U.S. Cl. CPC G06F 12/0891; G06F 12/0828; G06F 13/1673

(57) ABSTRACT

Techniques for coherent processor cache control are disclosed. A plurality of processor cores is accessed. Each processor of the plurality of processor cores includes a shared local cache, and the plurality of processor cores implements special cache coherency operations. An evict buffer is coupled to the plurality of processor cores. The evict buffer is shared among the plurality of processor cores, and the evict buffer enables delayed writes. Evict buffer writes are monitored. The monitoring evict buffer writes identifies a special cache coherency operation. The special cache coherency operation that was identified comprises a global snoop operation. The global snoop operation is initiated from a non-local agent within a globally coherent system. An evict buffer entry is marked. The marking corresponds to the special cache coherency operation that was identified, and the marking enables management of cache evict duplication.

### RELATED APPLICATIONS

This application claims the benefit of U.S. provisional patent applications “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, and “Non-Blocking Vector Instruction Dispatch With Micro-Element Operations” Ser. No. 63/714,529, filed Oct. 31, 2024.

Each of the foregoing applications is hereby incorporated by reference in its entirety.

### FIELD OF ART

This application relates generally to cache management and more particularly to cache evict duplication management.

### BACKGROUND

Electronic devices have become commonplace and indeed essential to modern society. Principal among the electronic devices are those based on computer processors. The computer processors play a pivotal role across a wide range of industries and applications. The processors provide power to computers, laptops, tablets, and smartphones, and enable people to perform various tasks such as browsing the Internet, running applications, processing data, and communicating with others. Processors have revolutionized the way people work, play, communicate, and access information. Computer processors are fundamental to the growth of the Internet of Things. They are embedded in smart devices, sensors, and appliances to enable connectivity and data processing. Processors enable IoT and other devices to collect, analyze, and transmit data, allowing the automation, remote monitoring, and control of various systems including smart homes, industrial automation, healthcare devices, vehicles, and more. Processors are key components in communication and networking technologies. Processors are found in routers, switches, and modems, facilitating data transmission and network management. Processors are also used in telecommunications infrastructure, mobile network equipment, and wireless devices, enabling seamless connectivity and communication.

Computer processors, which are based on integrated circuits (ICs), are designed using a Hardware Description Language (HDL). Examples of such languages can include Verilog, VHDL, etc. HDLs enable the description of behavioral, register transfer, gate, and switch level logic. HDLs provide designers with the ability to define levels of detail. Behavioral level logic supports a set of instructions executed sequentially, while register transfer level logic allows for the transfer of data between registers, driven by an explicit clock and gate level logic. The HDL can be used to create text models that represent logic circuits. The models can be processed by a synthesis program, followed by a simulation or emulation program, to test the logic design. The design process may include Register Level Transfer (RTL) abstractions that define the synthesizable data provided to logic synthesis tools which in turn create the gate-level design abstraction that is used for downstream implementation operations.

The main categories of computer processors include Complex Instruction Set Computer (CISC) types, and Reduced Instruction Set Computer (RISC) types. In a CISC processor, one instruction may execute several low-level operations. The low-level operations can include memory access for loading from and storing to memory, an arithmetic operation, a logical operation, and so on. By contrast, in a RISC processor, the instruction sets tend to be smaller than the instruction sets of CISC processors, and the instructions each perform smaller operations, thus requiring more RISC instructions to perform a particular task. The advantage to the RISC instructions is that they can be executed faster and may also be executed in a pipelined manner. The pipeline stages can include fetch, decode, and execute. Each of these pipeline stages may take one clock cycle, and thus, the pipelined operation can allow RISC processors to operate on more than one, simpler instruction per clock cycle, thereby improving processing throughput.

### SUMMARY

In disclosed techniques, the cache management issues are addressed by cache evict duplication management. The cache evict duplication management can be applied to a compute coherency block (CCB). A compute coherency block can include a plurality of processor cores, shared local caches, shared intermediate caches, a shared system memory, and so on. Each processor core includes a shared local cache. The shared local cache can be used to store cache lines, blocks of cache lines, etc. The cache lines and blocks of cache lines can be loaded from memory such as a shared system memory. Each local processor core can process cache lines within the local cache based on operations performed by the processor cores. If a processor writes or stores data to the shared local cache, the data becomes “dirty”. That is, the data in the local cache is different from the data in the shared memory system and other local caches. In order to maintain coherency across a compute coherency block, an evict buffer write operation can be monitored. The monitoring identifies a special cache coherency operation. The special cache coherency operation that was identified can include a global snoop operation.

Cache management is enabled by cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

A processor-implemented method for cache management is disclosed comprising: accessing a plurality of processor cores, wherein each processor of the plurality of processor cores includes a shared local cache, and wherein the plurality of processor cores implements special cache coherency operations; coupling an evict buffer to the plurality of processor cores, wherein the evict buffer is shared among the plurality of processor cores, and wherein the evict buffer enables delayed writes; monitoring evict buffer writes, wherein the monitoring evict buffer writes identifies a special cache coherency operation; and marking an evict buffer entry, wherein the marking corresponds to the special cache coherency operation that was identified, and wherein the marking enables management of cache evict duplication. Some embodiments comprise receiving an additional evict buffer write by the evict buffer. Some embodiments comprise performing a fast compare between the additional evict buffer write and the evict buffer entry that was marked to detect duplication. In embodiments, the comparing is based on a partial address of the evict buffer entry. In embodiments, the partial address comprises a cache set index.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for cache evict duplication management.

FIG. 2 is a flow diagram for replay buffer usage.

FIG. 3 is a system block diagram showing cache evict usage.

FIG. 4 is a block diagram illustrating a RISC-V™ processor.

FIG. 5 is a block diagram for a pipeline.

FIG. 6 is a system block diagram illustrating processor cores with cache management.

FIG. 7 is a system block diagram showing a compute coherency block (CCB).

FIG. 8 is a system diagram for cache evict duplication management.

### DETAILED DESCRIPTION

People around the globe interact daily with a wide variety of electronic devices. These electronic devices can include desirable features such as large or small, stationary or portable, and powerful or simple, among others. Popular electronic devices include personal electronic devices such as computers, handheld electronic devices, and smartwatches. The electronic devices also feature household devices including kitchen and cleaning appliances; personal, private, and mass transportation vehicles; and medical equipment; among many other familiar devices. Each of these devices is constructed with one type, or often many types, of integrated circuit or chip. The chips enable many required, useful, and desirable features by performing processing and control tasks. The electronic processors enable the devices to execute a potentially vast number of applications. The applications include data processing; entertainment; messaging; patient monitoring; telephony; vehicle access, configuration and operation control; etc. Further electronic elements are coupled to the processors to enable the processors to execute the features and applications. The further elements typically include one or more of memories, radios, networking channels, peripherals, touch screens, battery and power controllers, and so on.

Portions or blocks of the contents of a shared, or common, memory can be moved to local cache memory to boost processor performance. The local cache memory is smaller, faster, and located closer to the processor than is the shared memory. The local cache can be shared between processors, enabling local data exchange between the processors. The use of local cache memory is computationally beneficial because the local cache memory takes advantage of “locality” of instructions and data typically present in application code as the code is executed by the processors. Coupling the cache memory to processors drastically reduces memory access times because of the adjacency of the instructions and the data. A processor does not need to send a request across a common bus, across a crossbar switch, through buffers, and so on to access the instructions and data. Similarly, the processor does not experience the delays associated with the shared bus, buffers, crossbar switch, etc. The cache memory can be accessed by one, some, or all of a plurality of processors without having to access the slower common memory, thereby reducing access time and increasing processing speed. However, the use of smaller cache memory dictates that new cache lines must be brought into the cache memory to replace no-longer-needed cache lines (called a cache miss, which requires a cache line fill), and that existing cache lines in the cache memory that are no longer synchronized (coherent) must be evicted and managed across all caches and the common memory. The evicting cache lines and filling cache lines is accomplished using cache management techniques.

The execution rate of data processing operations such as those associated with large datasets, large numbers of similar processing jobs, and so on can be increased by using one or more local or “cache” memories. A cache memory can be used to store a local copy of the data to be processed, thereby making the data easily accessible. A cache memory, which by design is typically smaller and has much lower access times than a shared, common memory, can be coupled between the common memory and the processor cores. Further, each processor core can include a local cache, thereby adding additional storage in which copies of the data can be stored. As the processor cores process data, they search first within the cache memory for an address containing the data. If the address is not present within the cache, then a “cache miss” occurs, and the data requested by the processor cores can be obtained from an address within one or more higher levels of cache. If a cache miss occurs with the higher-level caches, then the requested data can be obtained from the address in the common memory. Data access by one or more processors using the cache memory is highly preferable to accessing common memory because of reduced latency associated with accessing the local cache memory as opposed to the remote common memory. The advantage of accessing data within the cache is further enhanced by the “locality of reference”. The locality of reference indicates that code that is being executed tends to access a substantially similar set of memory addresses. The locality of reference can apply whether the memory addresses are located in the common memory, a higher-level cache, or the local cache memory. By loading the contents of a set of common memory addresses into the cache, the processor cores are, for a number of cycles, more likely to find the requested data within the cache. As a result, the processor cores can obtain the requested data faster from the cache than if the requested data were obtained from the common memory. However, due to the smaller size of the cache with respect to the common memory, a cache miss can occur when the requested memory address is not present within the cache. One cache replacement technique that can be implemented loads a new block of data from the common memory into the local cache memory, where the new block contains one or more cache lines, and where a cache line can include the requested address. Thus, after the one or more cache lines are transferred to the cache, processing can again continue by accessing the faster cache rather than the slower common memory.

The processor cores can read a copy of data from a memory such as a cache memory, process the data, and then write the processed data back to the cache. As a result of the processing, the contents of the cache can be different from the contents of other caches and of the common memory. Cache management techniques can be used to keep the state of the data in the common memory and the shared data in the one or more shared caches or local caches “in sync” or coherent. A complementary problem can occur when out-of-date data remains in the cache after the contents of the common memory are updated. As before, this data state discrepancy can be remedied using cache management techniques that can make the data coherent. In embodiments, additional local caches can be coupled to processors, groupings of processors, etc. While the additional local caches can greatly increase processing speed, the additional caches further complicate cache management. Techniques presented herein address cache management in general, and cache evict management in particular, between shared local caches and additional shared memory. The additional shared memory can include intermediate caches, shared system memory, and the like. The presented techniques further address duplicate writes to an evict buffer. The evict buffer holds write operations prior to committing the write operations to system memory. The evict buffer writes can be delayed prior to execution in order to enable processes running on other processor cores to access data before the data is overwritten. Further, when an additional evict buffer write is received, a fast compare is performed to determine whether the additional evict buffer write is attempting to access the same memory location as the target location of another evict buffer write. The operation that caused the additional evict buffer write is sent to a replay buffer, and a full compare can be performed a cycle later. If a full compare is detected (e.g., a duplication), then the additional evict buffer write can be coordinated with other evict buffer writes that access the same memory address to avoid potential data race conditions. Else, the operation that caused the additional evict buffer write is marked in the replay buffer based on a duplication mismatch. The operation that caused the additional evict buffer write is then replayed.

Techniques for cache management using cache evict duplication management are described. The cache management can maintain cache line validity and cache coherency among one or more processor cores, local caches coupled to each processor core, common memories, shared caches, and so on. The processor cores can be used to accomplish a variety of data processing tasks. A processor cores can include a standalone processor, a processor chip, a multi-core processor, and the like. The processing of data can be significantly enhanced by using two or more processor cores (e.g., parallel processors) to process the data. The processor cores can be performing substantially similar operations, where the processor cores can process different portions or blocks of data in parallel. The processor cores can be performing substantially different operations, where the processor cores can process different blocks of data or may try to perform different operations on the same data. Whether the operations performed by the processor cores are substantially similar or not, managing how processor cores access data is critical to successfully processing the data. Since the processor cores can operate on data in shared storage such as a common memory structure, and on copies of the common memory data loaded into local caches, data coherency must be maintained between the common storage and the local caches. Thus, when changes are made to a copy of the data, the changes must be propagated to all other copies of the data and to the common memory. Before propagating or promoting changes of the data to the common memory, the writes, herein referred to as evict buffer writes, are compared to determine whether the writes access a substantially similar address. The comparing is accomplished by performing a fast compare and, if required, a full compare. The fast compare is accomplished based on a partial address of an evict buffer entry. The partial address can be based on a cache set index. If a fast compare identifies a “match” between an evict buffer write and an additional evict buffer write, the operation that causes the additional write is sent to a replay buffer a cycle later, after a full compare is performed by the evict buffer. If the addresses match and indicate a duplicate address, the evict buffer write and the additional evict buffer write can be orchestrated in order to avoid a data race condition. If an address mismatch is determined, then the additional evict buffer write can be replayed.

Snoop operations, which can be based on access operations such as write operations generated by processor cores, can be used to determine whether a difference exists between data in the common memory and data in the one or more local caches. If differences are detected, then a cache maintenance operation can resynchronize the data between the common memory and the one or more caches. The cache maintenance operations can be based on transferring cache lines between the compute coherency block cache and the shared common memory, or between the compute coherency block cache and other compute coherency block caches. The transferring can be accomplished using a bus interface unit. The bus interface can provide access to the common memory. In addition to transfers from the common memory to local caches and shared caches based on cache misses, cache transfers can also occur from the local caches and the shared caches to the common memory as a result of changes performed by the processor cores to the cache contents. The updated or “dirty” cache contents can be transferred to the common memory and can be copied to other caches in order to maintain coherency.

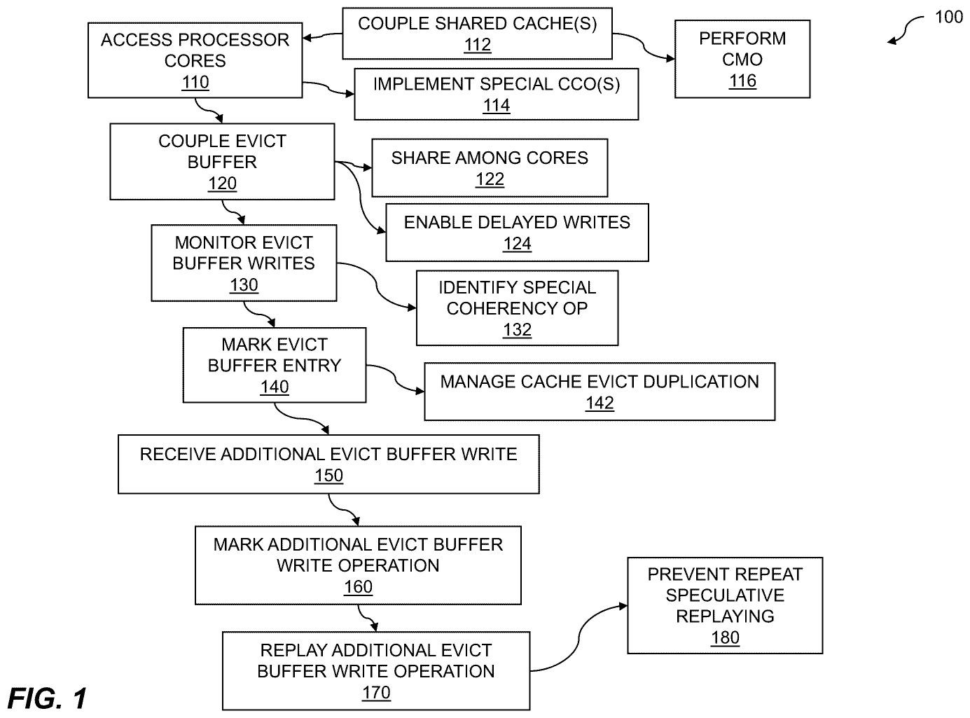

FIG. 1 is a flow diagram for cache evict duplication management. The cache evict duplication management can be performed for a coherency domain. The coherency domain can include a compute coherency block (described later). The compute coherency domain can include one or more processor cores, a shared local cache coupled to two or more processor cores, shared caches, common memory, a processor, one or more processor cores, and so on. A processor can include a multicore processor such as a RISC-V™ processor. The processor cores can comprise homogeneous processor cores or heterogeneous processor cores. The included cores can have substantially similar capabilities or substantially different capabilities. The processor cores can comprise further elements which can work in cooperation with the processor cores. The processor cores and the further elements can be coupled to a network, where the network can enable communications among the processors and the various elements. The network can include a network-on-chip (NoC). The further elements can include one or more of physical memory protection (PMP) elements, memory management (MMU) elements, level 1 (L1) caches such as instruction caches and data caches, level 2 (L2) caches, and the like. The multicore processor can further include a level 3 (L3) cache, test and debug support such as Joint Test Action Group (JTAG) elements, a platform-level interrupt controller (PLIC), an advanced core local interrupter (ACLINT), and so on. In addition to the elements just described, the multicore processor can include one or more interfaces. The interfaces can include one or more industry standard interfaces, interfaces specific to the multicore processor, and the like. In embodiments, the interfaces can include an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. The interfaces can enable connection between the multicore processor and an interconnect. In embodiments, the interconnect can include an AXI™ interconnect. The interconnect can enable the multicore processor to access a variety of elements such as storage elements, communications elements, peripherals, memory mapped input/output elements, etc.

The flow 100 includes accessing a plurality of processor cores 110. The processor cores can include homogeneous processor cores, heterogeneous processor cores, and so on. The cores can include general purpose cores, specialty cores, custom cores, and the like. In embodiments, the cores can be associated with a multicore processor such as a RISC-V™ processor. The cores can be included in one or more integrated circuits or “chips”, application-specific integrated circuits (ASICs), programmable gate arrays (PGAs), etc. The cores can be included in the form of a high-level design language (HDL) delivery. In embodiments, the plurality of processor cores can include a coherency domain. The coherency domain can be used to maintain coherency among processor cores, processor cores and one or more cache memories, processor cores and one or more common memory structures, etc. In the flow 100, each processor of the plurality of processor cores includes a shared local cache 112. A shared local cache can include a dedicated local cache. The dedicated local cache can include a single level cache, a multilevel cache, and so on. A dedicated local cache can be coupled to more than one processor core. In embodiments, the dedicated local cache can be included in a compute coherency domain (discussed below). Thus, coherency can be maintained among the plurality of processor cores, the dedicated local caches, and a common memory structure.

In embodiments, the shared local cache can be coupled to a grouping of two or more processor cores of the plurality of processor cores. Each processor core can load data from the shared local cache, modify the data, and store the modified data back the shared local cache. In embodiments, the shared local cache can be shared among the two or more processor cores. The shared local cache can be used to transfer data between the processors coupled to it. In embodiments, the grouping of two or more processor cores and the shared local cache can operate using local coherency. The local coherency can manage memory access operations such as load operations and store operations so that data race conditions can be avoided. The local coherency can prevent valid data from being overwritten, can block the reading of stale data, etc. In embodiments, the local coherency can be distinct from a global coherency. The local coherency can enable parallel processing of data with the shared local cache by the processor cores that are coupled to the shared local cache. Embodiments further include performing a cache maintenance operation in the grouping of two or more processor cores and the shared local cache. Noted throughout, the cache maintenance operations are used to maintain cache coherency among processor cores, shared local caches, etc. The cache maintenance operations can include a cache line zeroing operation, a cache line cleaning operation, a cache line flushing operation, a cache line invalidating operation, and so on. The cache maintenance operations can maintain cache coherency beyond the local coherency. In embodiments, the cache maintenance operation can generate cache coherency transactions between the global coherency and the local coherency.

In the flow 100, the plurality of processor cores implements special cache coherency operations 114. The cache coherency operations can be used to maintain data coherency across a block such as a compute coherency block. The cache coherency is necessary because copies of data in common memory such as a shared system memory can be loaded into one or more local caches. As data within the local caches is processed, changes can be made to the data, thereby introducing differences between the data in a local cache, local copies of data in other local caches, and data in the shared memory. The cache coherency operations can include a cache line zeroing operation, a cache line cleaning operation, a cache line flushing operation, a cache line invalidating operation, and so on. In embodiments, the cache coherency operation can include a global snoop operation. A global snoop operation can detect whether more than one memory access operation such as a store or write operation targets a substantially similar address in storage. The flow 100 further includes performing a cache maintenance operation 116 in the grouping of two or more processor cores and the shared local cache. The cache maintenance can update the contents of the shared common memory, local copies of data with caches, and so on. In embodiments, the cache maintenance operation can generate cache coherency transactions between a global coherency and a local coherency. The global coherency can maintain coherency across all shared local caches, intermediate caches, and the shared common memory. In embodiments, the local coherency is distinct from a global coherency. The local coherency can include coherency between processor cores coupled to the same shared local cache. The local coherency can orchestrate data access operations in order to avoid data race conditions. The avoidance of data race conditions can be accomplished using a snoop operation. Further embodiments can include performing a global snoop operation on the shared local cache. The global snoop operation can be used to determine if other local caches contain changed or “dirty” data, have updated the shared common memory, etc. The global snoop operation can be used to detect write operations that are associated with other local caches.

The flow 100 includes coupling an evict buffer 120 to the plurality of processor cores. An evict buffer can be used to hold data such as evicted cache lines prior to writing the cache lines back to the shared common memory. Recall that a local cache can contain a local copy of data obtained from the shared common memory. The obtained data can include cache lines, blocks of cache lines, and so on. The contents of a cache line within the local cache can be modified by a local processor core. The cache line thus differs from the cache line in the shared common memory, necessitating a cache maintenance operation to enable coherency between the local cache at the shared common memory, the local cache and other local caches, etc. The changed cache line can be “evicted” by the local cache by placing the changed cache line into the evict buffer for writing back to the shared common memory and/or other storage. In the flow 100, the evict buffer is shared among the plurality of processor cores 122. The evict buffer can serve as a “clearing house” for writes of evicted data such as cache lines back to the shared memory. The evict buffer can hold evict buffer write operations until the cache lines associated with the write operations can be promoted to the common memory. In the flow 100, the evict buffer enables delayed writes 124. The delaying of writes can enable data coherency to be accomplished. The delayed writes can prevent data race conditions.

The flow 100 includes monitoring evict buffer writes 130. The monitoring the evict buffer can include monitoring operations associated with the evict buffer writes. The operations can include cache coherency operations. The cache coherency operations can be applied to cache lines, cache blocks, etc. The monitoring can include checking for one or more particular cache coherency operations. In the flow 100, the monitoring evict buffer writes identifies a special cache coherency operation 132. The special cache coherency operation can include one of the cache line operations that can originate within a coherency block. In embodiments, the special cache coherency operation that was identified comprises a global snoop operation. The global snoop operation can include an operation that snoops for an evict buffer write that targets a specific shared memory address. In embodiments, the global snoop operation can be initiated from an agent within a globally coherent system. The globally coherent system can include a compute coherency block (CCB). In other embodiments, the special cache coherency operation that was identified can include a cache maintenance operation (CMO). In embodiments, the cache block operations can include a cache line zeroing operation, a cache line cleaning operation, a cache line flushing operation, a cache line invalidating operation, and so on. In embodiments, the CMO can include a cache block operation (CBO) CLEAN instruction. The CLEAN operation can include cleaning the dirty data by writing or promoting the dirty data from a shared local cache to the shared common memory.

The flow 100 includes marking an evict buffer entry 140, wherein the marking corresponds to the special cache coherency operation that was identified. The marking can be accomplished using a flag, a bit, a code, and so on. The memory access operation can signal that an additional evict buffer write is being generated. The special cache coherency operation, such as a global snoop operation, can initiate an action to be performed on dirty data. In embodiments, the special cache coherency operation that was identified can cause dirty data to be written into the evict buffer. Discussed previously, the evict buffer can be used to hold memory access operations such as write operations, prior to the operations being executed. The evict buffer can delay or retime execution of a write operation. The action performed can include a cache management operation. In the flow 100, the marking enables management 142 of cache evict duplication. Discussed below, each evict buffer write accesses an address in a memory such as the shared common memory. A CMO may insert a line from the shared cache into the evict buffer associated with the cache. Subsequently the line may be evicted from the cache due to a capacity miss, for example, thus causing the duplication. Two or more writes can cause a duplication. Since the two or more writes access the same address, then writes must be ordered, delayed, or otherwise managed so that a data race condition can be avoided. The data race condition can include read-before-write, write-after-read, and so on.

The flow 100 further includes receiving an additional evict buffer write 150 by the evict buffer. The additional evict buffer write can originate from a processor core within the plurality of processor cores. The additional evict buffer write can be initiated as a result of a capacity miss within the shared local cache, that is, an additional cache line needs to be brought into the cache, which requires eviction of an existing cache line entry to make space for a new cache line. A duplication can occur when two or more evict buffer writes target the same memory address. To determine whether a duplication occurs, target addresses of an evict buffer write and an additional evict buffer write can be compared. The comparing can be accomplished using one or more compare operations. Embodiments can further include performing a fast compare between the additional evict buffer write and the evict buffer entry that was marked to detect duplication. The fast compare can include an operation which can determine whether target addresses of the additional evict buffer write and the original evict buffer write are at least adjacent in memory. In embodiments, the comparing can be based on a partial address of the evict buffer entry. The partial address can include a few bits of the address, a byte of the address, and so on. The partial address can include the most significant bits, most significant byte, etc. In embodiments, the partial address can include a cache set index. A fast compare of the cache set index can be used to determine whether the target addresses include addresses within the same cache set index.

Further embodiments include sending the operation that caused the additional evict buffer write to a replay buffer, based on a duplication match in the fast compare. Since the possibility of a duplication match was identified by the fast compare, a more detailed match is required to determine whether a duplication match or mismatch (e.g., no duplication) condition occurs. Embodiments can include performing a full compare between the additional evict buffer write with the evict buffer entry that was marked. The full compare can include a bit-by-bit compare. The fast compare and the full compare operations can be achieved using hardware, software, a combination of hardware and software, etc. The fast compare and the full compare operations can be performed using logic. In embodiments, logic for the fast compare and the full compare comprises shared logic. The flow 100 further includes marking, in the replay buffer, the operation that caused the additional evict buffer write 160, based on a duplication mismatch in the full compare. The marking can be accomplished using a bit, a flag, etc., as described previously. The mismatch can indicate that the although the evict buffer write and the additional evict buffer write targeted addresses within the same cache set, the addresses did not target the same address.

The flow 100 further includes replaying 170 the operation that caused the additional evict buffer write, based on the duplication mismatch marking and a re-presentation of the operation that caused the additional evict buffer write from the replay buffer. Recall that when an evict buffer write is received, a fast compare is performed to compare the target address of the evict buffer write with other writes in the buffer. Since a fast compare has already been performed, repeating the fast compare would be a wasteful use of computation resources. In embodiments, the re-presentation by the replay buffer can force an override of a subsequent fast compare.

The flow 100 includes preventing repeat speculative replaying 180. When a speculative operation that causes an erroneous entry in the evict buffer is not executed, the speculative eviction operation is placed in the replay buffer, as described generally above. Then, that replay buffer entry, which was caused by the erroneous speculative evict, will be replayed. However, the repeat speculation is avoided in the following manner. First, the corresponding cache set way (i.e., the entry in an indexed cache set) chosen for eviction is stored in the replay buffer and provided as part of the replay information. Second, the replayed access is forced to use the same cache set way, which causes the same eviction physical address to be used to write the evict buffer. Third, the eviction PA from the initial erroneous speculation is stored in the replay buffer and provided as part of the replay information. Finally, because the occurrence of the replay is known early in the pipeline execution, the full physical address can be compared, and thus, the write is never speculative on the replay. Note that it may or may not “hit” in the evict buffer, because time has elapsed since the speculation pass, and the evict buffer entry may be invalid at that point, or it may have been replaced by another write with a different physical address, or the line referenced in the cache set may have changed.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

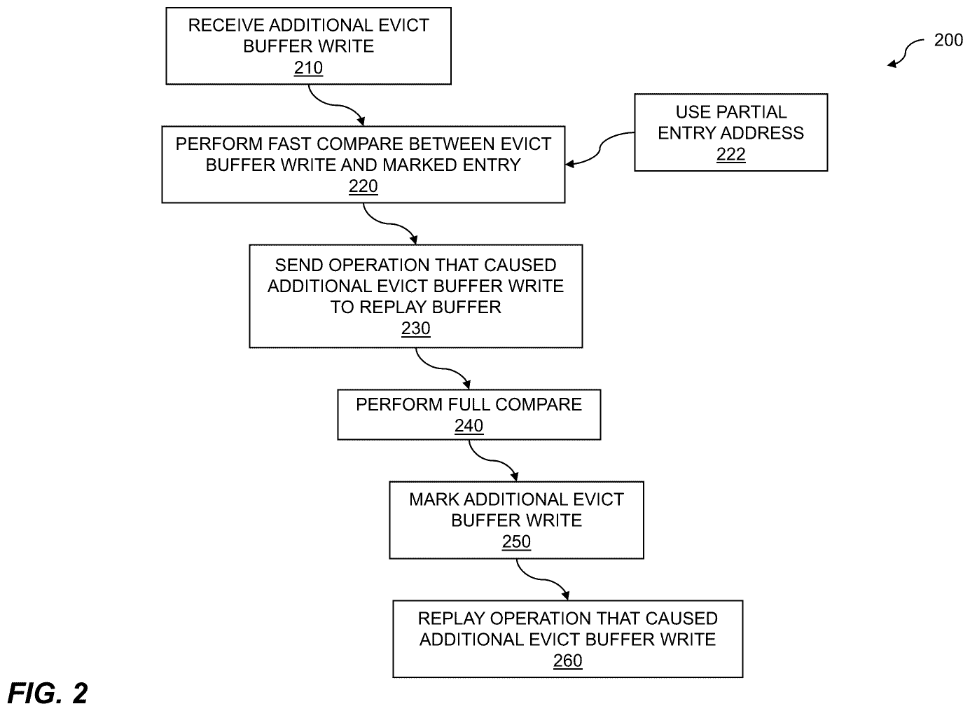

FIG. 2 is a flow diagram for replay buffer usage. Discussed previously and throughout, an additional evict buffer write operation can be received. The target memory address of the additional evict buffer write can be matched to target addresses of writes present in the evict buffer. The matching is performed based on a fast compare and a full compare. If the fast compare, which can be based on a cache set index, indicates a possible match, then the operation that causes the additional evict buffer write can be sent to a replay buffer a cycle later, after a full compare is performed by the evict buffer. If the full compare indicates a match or duplication, then duplicate evict buffer writes can be orchestrated to avoid data race conditions. If a mismatch is indicated, then the operation that caused the additional evict buffer write can be replayed from the replay buffer. Replay buffer usage enables cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

The flow 200 includes receiving 210 an additional evict buffer write by the evict buffer. The additional evict buffer write can be in addition to one or more evict buffer writes previously placed in the evict buffer. The additional evict buffer write can be received due to a capacity miss within the shared local cache. The local copy of data can include a local copy of common data loaded from a share memory such as a common memory that is accessible to the plurality of processor cores. The local copy of the data can include data within a local cache shared with the processor and one or more other processors. In order to maintain data coherency within a compute coherency block (CCB), one or more updates or changes to local copies of the data must be reflected out to the common data in the common memory or other memory. Further, updates to the local data must be reflected out to other local copies of the common data stored in other caches such as local caches associated with other processor cores.

The flow 200 can further include performing a fast compare 220 between the additional evict buffer write and the evict buffer entry that was marked to detect duplication. Discussed previously, an evict buffer entry can be marked, where the marking corresponds to an identified coherency operation. In embodiments, the special cache coherency operation that was identified can include a global snoop operation. A snoop operation can be used to determine whether a data operation such as a write operation is attempting to update memory such as the shared memory as a result of a modification to a local copy of the shared data. The snoop operation can include a global snoop operation. In embodiments, the global snoop operation can be initiated from an agent within a globally coherent system. The agent can include a processor, processor core, etc. The fast compare can determine whether another evict buffer write may be targeting a substantially similar memory address. The target address can be within a block of addresses. In the flow 200, the comparing can be based on a partial address 222 of the evict buffer entry. In a usage example, the partial address can include most significant bits, a most significant byte, and so on. In embodiments, the partial address can include a cache set index. The cache set index can include a set of cache blocks, cache lines, etc., present within a cache such as a local cache.

The flow 200 further includes sending 230 the additional evict buffer write to a replay buffer, based on a duplication match in the fast compare. The replay buffer can be used to hold the operation that caused the additional evict buffer write that may access an address that can also be accessed by an evict buffer write already in the evict buffer. It is important to note that the “match” was based on a fast compare, where the fast compare used only a partial address. To determine whether an address is accessed by both the additional evict buffer write and an evict buffer write in the evict buffer, a more detailed examination of target addresses is required. The flow 200 further includes performing a full compare 240 in the evict buffer between the additional evict buffer write 250, whose operation that caused the additional evict buffer write was sent to the replay buffer, with the evict buffer entry that was marked. The full compare can compare the full target address associated with the additional evict buffer write with one or more evict buffer writes in the evict buffer. The full compare can identify a match which can indicate a duplication, or a mismatch which can indicate that the target addresses are not duplicates. The fast compare and the full compare can be performed using hardware, software, a combination of hardware and software, etc. The fast compare and the full compare can be performed using logic. In embodiments, the fast compare and the full compare can include shared logic.

The flow 200 further includes replaying 260 the operation that caused the additional evict buffer write, based on the duplication mismatch marking and a re-presentation of the operation that caused the additional evict buffer write from the replay buffer. If a full compare results in a duplication mismatch, then the additional evict buffer write is not a duplication of an evict buffer write in the evict buffer. As a result, the operation that caused the additional evict buffer write can be “replayed”. The replaying the operation that caused the additional evict buffer write can be accomplished by re-presenting the operation that caused the additional evict buffer write. Recall that when an evict buffer write is received, a comparison operation such as a fast compare is performed to determine whether there is an evict duplication between the additional evict buffer write and an evict buffer write. Since a fast compare of the additional evict buffer write was previously performed when the additional evict buffer write was received, a new fast compare can be omitted. In embodiments, the re-presentation by the replay buffer can force an override of a subsequent fast compare. The overriding of the subsequent fast compare can enable faster processing of the additional evict buffer write. However, if the duplication is indeed a match, based on the full compare, the replay of the additional evict buffer write can be synchronized to the successful commitment to memory of the special cache operation evict buffer write. This can prevent needless presentations of the operation that caused the additional evict buffer write out of the replay buffer.

Snoop operations can be used to monitor transactions such as bus transactions, where the bus transactions can be associated with memory access operations. The snoop operations can be generated by the compute coherency block, where the snoop requests correspond to entries in the memory queue. The memory access operations, which can include cache line access operations, can include read, write, read-modify-write operations, etc. The snoop requests can be used to maintain coherency between data in the common memory and copies of the data in any caches. The snoop requests can determine whether data in the common memory or any shared copies of the data have been modified. If a modification has occurred, then the change can be propagated to all copies of the data so that all other copies of the data reflect the changes to the data. The copies of the data can be stored in cache memory, local memory, shared common memory, and so on. Thus, the snoop operations can request information associated with changes to local cache data, other local cache data, common memory data, and the like. A snoop response can be received in response to a snoop operation. A snoop operation can monitor memory access operations to determine whether an access operation can modify shared data at an address. If the access operation can modify data, then the snoop operation can determine whether a local copy of the shared data is the same as the modified data or different from the modified data. If different, then a coherency management operation can be performed to ensure that all copies of the shared data are coherent (i.e., substantially similar).

Cache maintenance operations can include cache block operations. A cache block can include a portion or block of common memory contents, where the block can be moved from the common memory into a local cache. In embodiments, the cache block operations can include a cache line zeroing operation, a cache line cleaning operation, a cache line flushing operation, and a cache line invalidating operation. These operations are discussed in detail below. The cache block operations can be used to maintain coherency. In embodiments, the cache line zeroing operation can include uniquely allocating a cache line at a given physical address with zero value. The zero value can be used to overwrite and thereby clear previous data. The zero value can indicate a reset value. The cache line can be set to a nonzero value if appropriate. In embodiments, the cache line cleaning operation can include making all copies of a cache line at a given physical address consistent with that of memory. Recall that the processors can be arranged in groupings of two or more processors and that each grouping can be coupled to a local cache. One or more of the local caches can contain a copy of the cache line. The line cleaning operation can set or make all copies of the cache line consistent with the common memory contents. In other embodiments, the cache line flushing operation can include flushing any dirty data for a cache line at a given physical address to memory and then invalidating any and all copies. The “dirty” data can result from processing a local copy of data within a local cache. The data within the local cache can be written to the common memory to update the contents of the physical address in the common memory. In further embodiments, the cache line invalidating operation can include invalidating any and all copies of a cache line at a given physical address without flushing dirty data. Having flushed data from a local cache to update the data at a corresponding location or physical address in the common memory, all remaining copies of the old data within other local caches becomes invalid.

The cache line instructions just described can be mapped to standard operations or transactions for cache maintenance, where the standard transactions can be associated with a given processor type. In embodiments, the processor type can include a RISC-V™ processor core. The standard cache maintenance transactions can differ when transactions occur from the cores and when transactions occur to the cores. The transactions can comprise a subset of cache maintenance operations, transactions, and so on. The subset of operations can be referred to as cache block operations (CBOs). The cache block operations can be mapped to standard transactions associated with an ARM™ Advanced extensible Interface (AXI™) Coherence Extensions (ACE™) interface, an Advanced Microcontroller Bus Architecture (AMBA™) Coherence Hub Interface (CHI™), etc. In embodiments, the cache coherency transactions can be issued globally before being issued locally. A globally issued transaction can include a transaction that enables cache coherency from a core to cores globally. The issuing cache coherency transactions globally can prevent invalid data from being processed by processor cores using local, outdated copies of the data. The issuing cache coherency transactions locally can maintain coherency within compute coherency blocks (CCBs), each managing a grouping of processors. In embodiments, the cache coherency transactions that are issued globally can complete before cache coherency transactions are issued locally. A variety of indicators, such as a flag, a semaphore, a message, a code, and the like, can be used to signify completion. In embodiments, an indication of completeness can include a response from the coherent network-on-chip.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

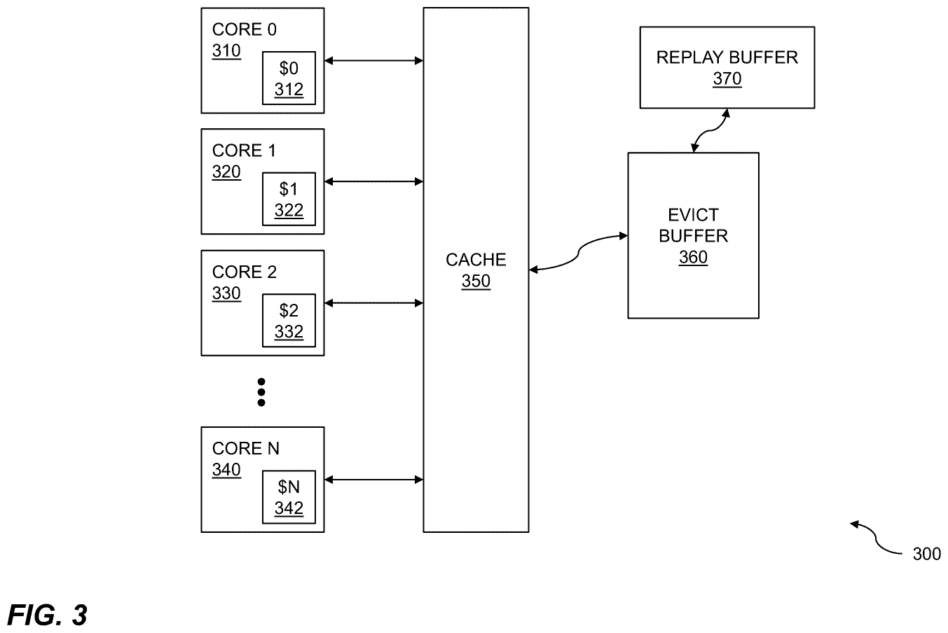

FIG. 3 is a system block diagram showing cache evict usage. A storage such as cache storage can hold information. The information that is held can include instructions or operations, data, processing results, and so on. The cache storage can include a local cache associated with a core such as a processor core, a cache shared between or among processor cores, a cache accessible to a plurality of processor cores, and so on. Accessing instructions and data within the local cache can be significantly faster than accessing the instructions and the data within a shared memory such as a shared memory system. The access is faster because the cache is smaller than the memory system and is located in close proximity to at least one processor core. The closer proximity of the cache can provide instructions and data without the additional access delays associated with a shared bus, a crossbar switch, buffers, slower access times of a large memory system, etc. However, coherency must be maintained between data in the local and other local caches, shared caches, the memory system, and so on. Maintaining coherency can include managing the order in which read operations and write operations are executed so that needed data is not overwritten before it can be read, data is written after the data is read, and the like. Cache coherency is enabled by cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication. The special cache coherency operation that was identified comprises a global snoop operation.

The system block diagram 300 includes a plurality of processor cores such as processor core 0 310, core 1 320, core 2 330, and core N 340. While four processor cores are shown, other numbers of cores can be included, as implied by core N. The processor cores can include multicore processors such as a RISC-V™ processor. The processor cores can generate read operations, which can access a common memory structure coupled to the processor cores. The read operations can be generated by any number of other processor cores located within a compute coherency domain (CCD). Each processor core can include a local cache. The local caches can include cache $0 312 associated with core 0 310; cache $1 322 associated with core 1 320; cache $2 332 associated with core 2 330; and cache $N 342 associated with core N 340. The local caches can hold one or more cache lines that can be operated on by the core associated with a local cache. The system block diagram 300 can include a cache 350. The cache can include a hierarchical cache. The hierarchical cache can be shared among the processors within the plurality of processor cores. The hierarchical cache can include a single level cache or a multilevel cache. The hierarchical cache can comprise a level two (L2) cache, a level three (L3) cache, a unified cache, and so on. The hierarchical cache can comprise a last level cache (LLC) for a processor core grouping.

Embodiments can include a coherent cache structure (not shown). The coherent cache structure can enable coherency maintenance between the one or more local caches such as local caches 312, 322, 332, and 342 associated with the processor cores 310, 320, 330, and 340, and the cache 350. The coherent cache structure can be managed using a cache line directory along with other compute coherency block logic and storage functionality. In embodiments, the coherency block can include a snoop generator. Snoop operations can be used to detect storage access operations that can change data at a storage address of interest. A storage address of interest can include a storage address associated with operations such as load and/or store operations. Recall that two or more processor cores can access the common memory, one or more local caches, memory queues, and so on. Access by a processor core to an address associated with any of the storage elements can change the data at that address. The snoop operations can be used to determine whether an access operation to a storage address could cause a cache coherency problem, such as overwriting data waiting to be read, reading old or stale data, and so on. In embodiments, the snoop operations can be based on physical addresses for the common memory structure. The physical addresses can include absolute, relative, offset, etc. addresses in the common memory structure.

The system block diagram 300 can include an evict buffer 360. The evict buffer is coupled to the plurality of processor cores and is shared among the plurality of processor cores. The evict buffer can store “dirty” data, where the dirty data includes data that has been changed in a cache such as a local cache, hierarchical cache, etc. The dirty data is the result of a change to a local copy of data loaded from shared storage. In order to maintain coherency of data, data that is changed in, for example, a local cache, must be written out to or stored in the shared storage. Further, other local copies of the data must reflect changes to the data. However, changes to other local copies of the data must be properly ordered to avoid loading of stale data, storing of data that is required by another process, and so on. The orchestrating of the writes to the evict buffer can be monitored to identify a special cache coherency operation. In embodiments, the special cache coherency operation that was identified can include a global snoop operation. The global snoop operation can look for memory access operations such as load operations and store operations. The monitoring of store operations can monitor for writing to a substantially similar storage location. In embodiments, the partial address can include a cache set index.

The system block diagram can include a replay buffer 370. The replay buffer can be used to store operations that need to be recirculated through a processor pipeline, including those that may cause a write to the evict buffer. Additional evict buffer writes are compared with evict buffer writes already in the evict buffer. The comparing can determine whether the additional evict buffer write is attempting to write to a storage location to which a previous evict buffer write is attempting to write. Embodiments can further include performing a fast compare between the additional evict buffer write and the evict buffer entry that was marked to detect duplication. A fast compare can be based on comparing a portion of address bits associated with the additional evict buffer write with address bits associated with evict buffer writes previously loaded into the evict buffer. The fast compare can indicate whether an address may be referenced by another evict buffer write. Embodiments can include sending the operation that caused the additional evict buffer write to a replay buffer, based on a duplication match in the fast compare. Since the fast compare can indicate that duplicate evict buffer writes (e.g., writes to the same storage location) may exist, a detailed search can be conducted to determine whether there is an exact match. Embodiments can include performing a full compare between the additional evict buffer write that was sent to the replay buffer with the evict buffer entry that was marked. The fast compare and the full compare can be accomplished using logic. In embodiments, logic for the fast compare and the full compare can include shared logic.

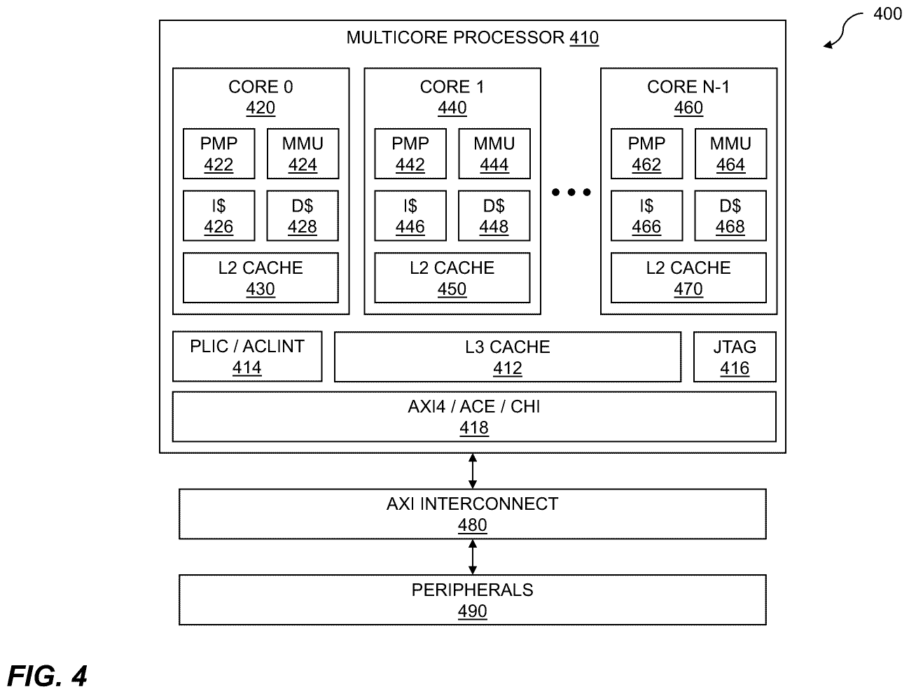

FIG. 4 is a block diagram illustrating a RISC-V™ processor. A processor can comprise two or more processor cores, where the processor cores can include homogeneous processor cores or heterogeneous processor cores. The processor, such as a RISC-V™ processor, can include a variety of elements. The elements can include a plurality of processor cores, one or more caches, memory protection and management units, local storage, and so on. The elements of the multicore processor can further include one or more of a private cache, a test interface such as a Joint Test Action Group (JTAG) test interface, one or more interfaces to a network such as a network-on-chip (NoC), a coupling to a common memory structure, peripherals, and the like. The multicore processor is enabled by cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

The block diagram 400 can include a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N−1 460, and so on. Each processor can comprise one or more elements. In embodiments, each core, including cores 0 through core N−1, can include a physical memory protection (PMP) element, such as PMP 422 for core 0; PMP 442 for core 1, and PMP 462 for core N−1. In a processor architecture such as the RISC-V™ architecture, a PMP can enable processor firmware to specify one or more regions of physical memory such as cache memory of the common memory, and to control permissions to access the regions of physical memory. The cores can include a memory management unit (MMU) such as MMU 424 for core 0, MMU 444 for core 1, and MMU 464 for core N−1. The memory management units can translate virtual addresses used by software running on the cores to physical memory addresses with caches, the common memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N−1. In addition to the level 1 instruction and data caches, each core can include a level 2 (L2) cache. The level 2 caches can include L2 cache 430 associated with core 0; L2 cache 450 associated with core 1; and L2 cache 470 associated with core N−1. Each core associated with multicore processor 410, such as core 0 420 and its associated cache(s), elements, and units, can be “coherency managed” by a CCB. Each CCB can communicate with other CCBs that comprise the coherency domain. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. The further elements can be unique to a given CCB or can be shared among various CCBs. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In embodiments, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

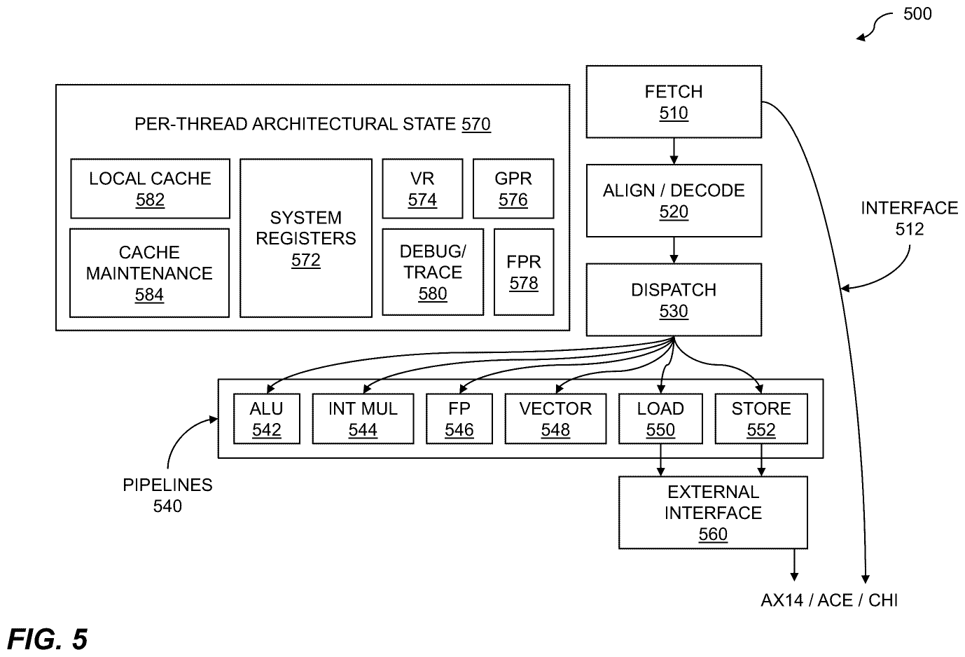

FIG. 5 is a block diagram for a pipeline. The use of one or more pipelines associated with a processor architecture can greatly enhance processing throughput. The processor architecture can be associated with one or more processor cores, multiprocessors, storage elements, and so on. The processing throughput can be increased because multiple operations can be executed in parallel. The use of one or more pipelines supports cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

The FIG. 500 shows a block diagram of a pipeline such as a processor core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 500 can include a dispatch block 530. The dispatch block can receive decoded instruction packets from the align and decode block. The decoded instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, to trigger one or more exceptions, and so on.

In embodiments, the plurality of processors can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VR) 574, general purpose registers (GPR) 576, and floating-point registers 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

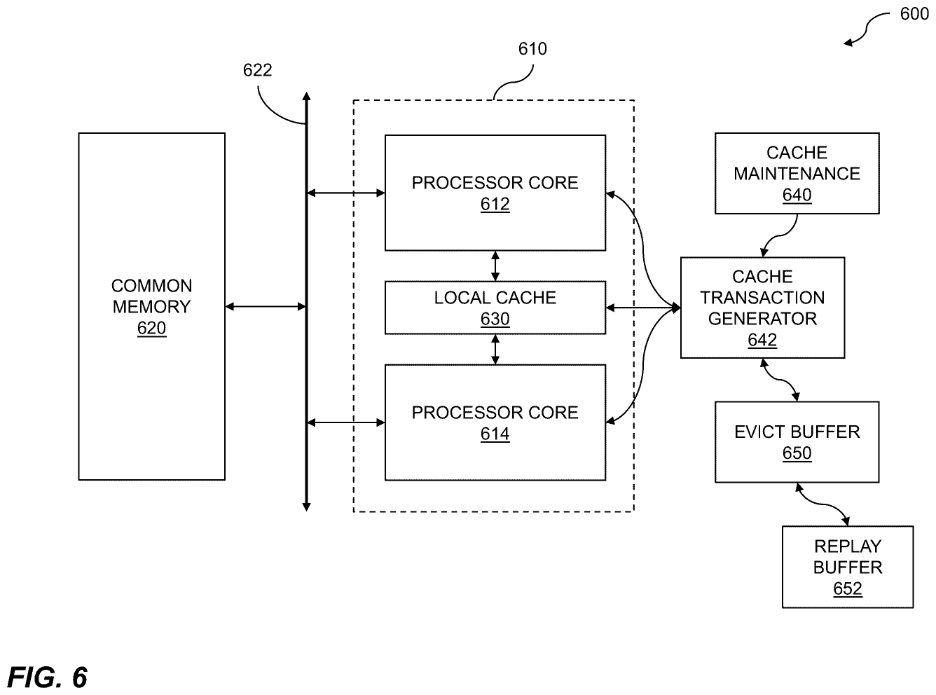

FIG. 6 is a system block diagram illustrating processor cores with cache management. In embodiments, each processor core can be coupled to a local cache. The processor cores and local caches can be arranged into groupings of two or more processor cores. In embodiments, a hierarchical cache can be coupled to the plurality of processor cores, where the plurality of processor cores and the hierarchical cache comprise a compute coherency block (CCB). The hierarchical cache and the local caches can be loaded with data from a source such as a common memory structure. The processor cores coupled to the hierarchical cache can process the data within the cache, causing the data to become “dirty” or different from the contents of the common memory. Since multiple groupings of processor cores can each be coupled to their own local caches, the problem of incoherency between the contents of the common memory structure, the hierarchical cache, and the local caches becomes highly complex. To resolve the coherency challenges, one or more coherency management operations can be applied to the data within the local caches, the hierarchical cache, and the common memory structure. An operation such as a snoop operation can examine common memory and cache access operations so that the access operations can be ordered, and cache coherency problems can be avoided. The coherency management operations enable cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

A system block diagram 600 of processor cores with cache management is shown. A multicore processor 610 can include a plurality of processor cores. The processor cores can include homogeneous processor cores, heterogeneous cores, and so on. In the system block diagram 600, two processor cores are shown, processor core 612 and processor core 614. The processor cores can be coupled to a common memory 620. The common memory can be shared by a plurality of multicore processors. The common memory can be coupled to the plurality of processor cores through a coherent network-on-chip 622. The network-on-chip can be colocated with the plurality of processor cores within an integrated circuit or chip, an application-specific integrated circuit (ASIC), a field programmable gate array (FPGA), and so on. The network-on-chip can be used to interconnect the plurality of processor cores and other elements within a system-on-chip (SoC) architecture. The network-on-chip can support coherency between the common memory 620 and one or more local caches (described below) using coherency transactions. In embodiments, the cache coherency transactions can enable coherency among the plurality of processor cores, one or more local caches, and the memory. The cache coherency can be accomplished based on coherency messages, cache misses, and the like.

The system block diagram 600 can include a local cache 630. The local cache can be coupled to a grouping of one or more processor cores within a plurality of processor cores. The local cache can include a multilevel cache. In embodiments, the local cache can be shared among the two or more processor cores. The cache can include a multiport cache. In embodiments, the grouping of two or more processor cores and the shared local cache can operate using local coherency. The local coherency can indicate to processors associated with a grouping of processors that the contents of the cache have been changed or made “dirty” by one or more processors within the grouping. In embodiments, the local coherency is distinct from the global coherency. That is, the coherency maintained for the local cache can be distinct from coherency between the local cache and the common memory, coherency between the local cache and one or more further local caches, etc.

The system block diagram 600 can include a cache maintenance element 640. The cache maintenance element can maintain local coherency of the local cache, coherency between the local cache and the common memory, coherency among local caches, and so on. Cache maintenance can be based on issuing cache transactions. In the system block diagram 600, the cache transaction can be provided by a cache transaction generator 642. In embodiments, the cache coherency transactions can enable coherency among the plurality of processor cores, one or more local caches, and the memory. The contents of the caches can become “dirty” by being changed. The cache contents changes can be accomplished by one or more processors processing data within the caches, by changes made to the contents of the common memory, and so on. In embodiments, the cache coherency transactions can be issued globally before being issued locally. Issuing the cache coherency transactions globally can ensure that the contents of the local caches are coherent with respect to the common memory. Issuing the cache coherency transactions locally can ensure coherency with respect to the plurality of processors within a given grouping. In embodiments, the cache coherency transactions that are issued globally can complete before cache coherency transactions are issued locally. The completion of the coherency transaction issued globally can include a response from the coherent network-on-chip.

The system block diagram 600 can include an evict buffer 650. The evict buffer can be shared among the plurality of processor cores such as processor cores 612 and 614. The evict buffer can hold memory access operations such as evict buffer write operations. An evict buffer write can be used to indicate that a cache line has become “dirty” by being modified by a processor such as a local processor. The cache line that has become dirty is associated with a local copy of data from memory such as a shared memory. In order to maintain coherency such as coherency of a compute coherency block (CCB), the dirty data must be written out to the shared storage, and all other local copies of the data must be updated. Before the dirty data can be written, a special cache coherency operation must be executed. The special cache coherency operation can include a global snoop operation. The global snoop operation compares a write operation target address so that the write operations can be performed in an order to prevent data race conditions. An additional evict buffer write can be received. The system block diagram 600 can include a replay buffer 652. Embodiments can include sending the operation that caused the additional evict buffer write to a replay buffer. The sending to the replay buffer can be based on a duplication match in a fast compare. When an additional evict buffer write is received by the evict buffer, a fast compare can be performed between the additional evict buffer write and an evict buffer entry that was marked to detect duplication. The fast compare can be based on a partial address of the evict buffer entry. By comparing only a partial address, a possible evict buffer write duplication can be identified within a single cycle. If no match is found, then the additional evict buffer write can be stored in the evict buffer. To determine whether an exact duplication exists, embodiments can further include performing a full compare between the additional evict buffer write that was sent to the replay buffer with the evict buffer entry that was marked. The fast compare and the full compare can be performed using logic. In embodiments, logic for the fast compare and the full compare can include shared logic.

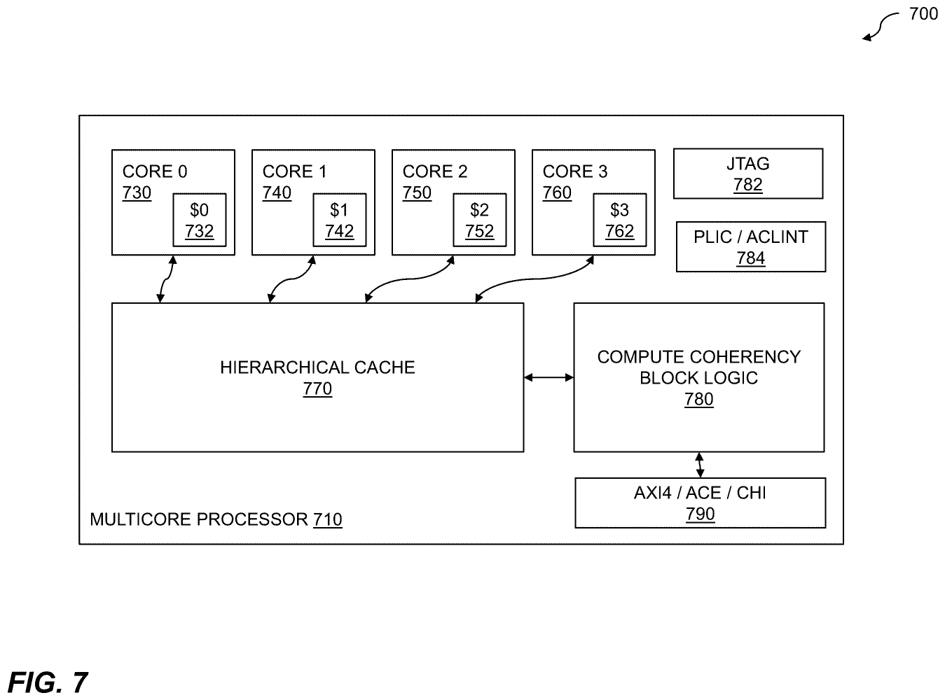

FIG. 7 is a system block diagram showing a compute coherency block (CCB). A compute coherency block can maintain coherency between processors that share a cache memory; between sets of processors that share cache memories and a shared cache; among processor/cache sets, a shared system cache, and system memory; and so on. That is, the compute coherency block can be used to maintain storage coherency throughout a system, from a cache associated with a processor core up through the system memory. The compute coherency is enabled by checking and controlling write operations from one or more processors into storage. The checking and controlling of write operations are enabled by cache evict duplication management. A plurality of processor cores is accessed, wherein each processor of the plurality of processor cores includes a shared local cache, and wherein the plurality of processor cores implements special cache coherency operations. An evict buffer is coupled to the plurality of processor cores, wherein the evict buffer is shared among the plurality of processor cores, and wherein the evict buffer enables delayed writes. Evict buffer writes are monitored, wherein the monitoring evict buffer writes identifies a special cache coherency operation. An evict buffer entry is marked, wherein the marking corresponds to the special cache coherency operation that was identified, and wherein the marking enables management of cache evict duplication.

The system block diagram 700 shows a multicore processor 710. The multicore processor includes compute coherency block (CCB) logic 780. The compute coherency block logic controls coherency among caches coupled to cores, a hierarchical cache, system memory, and so on. Multicore processor 710 includes core 0 730, core 1 740, core 2 750, and core 3 760. While four cores are shown in diagram 700, in practice, there can be more or fewer cores. As an example, disclosed embodiments can include 16, 32, or 64 cores. Each core comprises an onboard local cache, which is referred to as a level 1 (L1) cache. Core 0 730 includes local cache 732, core 1 740 includes local cache 742, core 2 750 includes local cache 752, and core 3 760 includes local cache 762.

The multicore processor 710 can further include a joint test action group (JTAG) element 782. The JTAG element 782 can be used to support diagnostics and debugging of programs and/or applications executing on the multicore processor 710. The diagnostics and debugging are enabled by providing access to the processor's internal registers, memory, and other resources. In embodiments, the JTAG element 782 enables functionality for step-by-step execution, setting breakpoints, examining the processor's state during program execution, and/or other relevant functions. The multicore processor 710 can further include a platform level interrupt controller (PLIC), and/or advanced core local interrupter (ACLINT) element 784. The PLIC/ACLINT supports features including, but not limited to, interrupt processing and timer functionalities. The multicore processor 710 can further include a hierarchical cache 770. The hierarchical cache 770 can be a level 2 (L2) cache that is shared among multiple cores within the multicore processor 710. In one or more embodiments, the hierarchical cache 770 is a last level cache (LLC). The multicore processor 710 can further include one or more interface elements 790, which can include standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), as previously described.

Multicore processor 710 further includes compute coherency block (CCB) logic 780. In one or more embodiments, the compute coherency block (CCB) logic 780 is responsible for maintaining coherency between one or more caches such as local caches associated with the processor cores, the hierarchical cache, a shared memory system, and so on. In embodiments, the CCB logic 780 interfaces to the hierarchical cache 770 and the interface elements 790. The CCB logic interfaces to the system memory through the interface elements. The compute coherency block logic can perform one or more cache maintenance operations. In embodiments, the CMO can include a cache block operation (CBO) CLEAN instruction. The CCB logic can perform one or more CMO operations in order to resolve data inconsistencies due to “dirty” data in one or more caches. The dirty data can result from changes to the local copies of shared memory contents in the local caches, copies of shared memory contents in the hierarchical cache, etc. The changes to the local copies of data or the hierarchical cache copies of the data can result from processing operations performed by the processor cores as the cores execute code. Similarly, data in the shared memory can be different from the data in a local cache due to an operation such as a write operation.

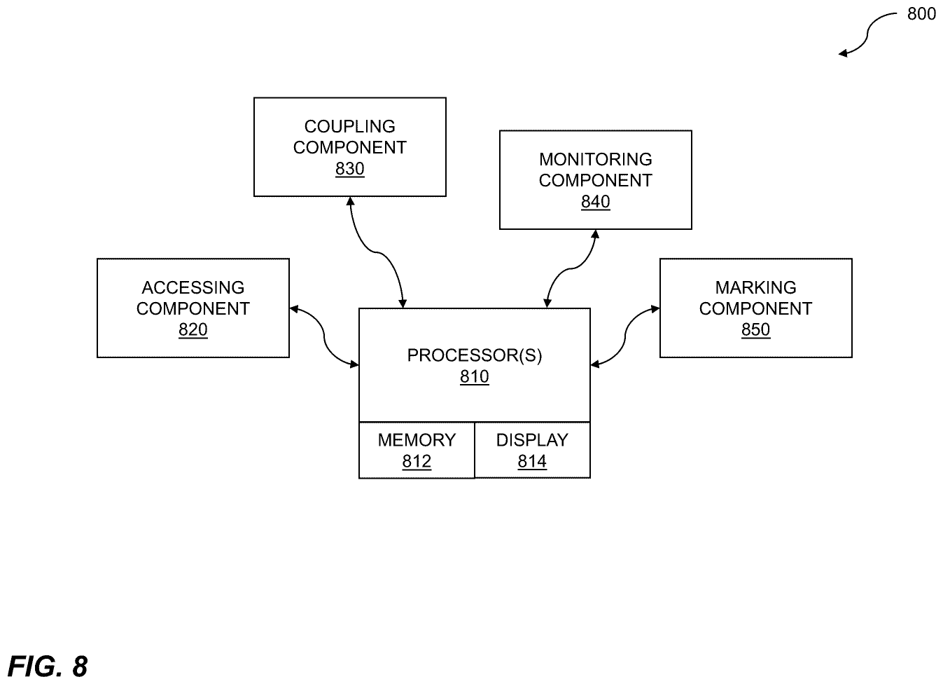

FIG. 8 is a system diagram for cache evict duplication management. The system can comprise a computer system for cache management. The computer system can be based on semiconductor logic. The system can include one or more of processors, memories, cache memories, queues, displays, and so on. The system 800 can include one or more processors 810. The processors can include standalone processors within integrated circuits or chips, processor cores in FPGAs or ASICs, two or more processor cores within a multiprocessor, and so on. The one or more processors 810 are coupled to a memory 812, which stores instructions, operations, etc. The memory can include one or more of local memory, cache memory, hierarchical cache memory, system memory such as shared system memory, etc. The system 800 can further include a display 814 coupled to the one or more processors 810. The display 814 can be used for displaying data, instructions, operations, memory queue contents, snoop operations, snoop responses, and the like. The operations can include cache maintenance operations. The operations can further include cache maintenance operations, Advanced extensible Interface (AXI™) Coherence Extensions (ACE™) cache transactions, Advanced Microcontroller Bus Architecture (AMBA™) Coherence Hub Interface (CHI™) transactions, etc.

In embodiments, one or more processors 810 are coupled to the memory 812, wherein the one or more processors, when executing the instructions which are stored, are configured to: access a plurality of processor cores, wherein each processor of the plurality of processor cores includes a shared local cache, and wherein the plurality of processor cores implements special cache coherency operations; couple an evict buffer to the plurality of processor cores, wherein the evict buffer is shared among the plurality of processor cores, and wherein the evict buffer enables delayed writes; monitor evict buffer writes, wherein the monitoring evict buffer writes identifies a special cache coherency operation; and mark an evict buffer entry, wherein the marking corresponds to the special cache coherency operation that was identified, and wherein the marking enables management of cache evict duplication.

The system 800 can include an accessing component 820. The accessing component 820 can access a plurality of processor cores. The processor cores can be accessed within one or more chips, FPGAs, ASICs, etc. In embodiments, the processor cores can include RISC-V™ processor cores. Each processor of the plurality of processor cores includes a local cache. The local cache can include a shared local cache. The local cache that can be coupled to each processor, can be colocated with its associated processor core, can be accessible by the processor core, and so on. In embodiments, the plurality of processor cores can implement special cache coherency operations. The cache coherency operations can include maintenance operations such as cache maintenance operations (CMOs). The cache coherency operations can include a cache line zeroing operation, a cache line cleaning operation, a cache line flushing operation, a cache line invalidating operation, and so on. In embodiments, the CMO comprises a cache block operation (CBO) CLEAN instruction. The plurality of processor cores and coupled local caches can include a coherency domain. The coherency can include coherency between the common memory and cache memory, such as level 1 (L1) cache memory. L1 cache memory can include local cache coupled to groupings of two or more processor cores. The coherency between the common memory and one or more local cache memories can be accomplished using cache maintenance operations (CMOs), described previously. In embodiments, two or more processor cores within the plurality of processor cores can generate read operations for a common memory structure coupled to the plurality of processor cores. The read operations for the common memory can occur based on cache misses to local cache, thereby requiring the read operations to be generated for the common memory. In embodiments, each processor of the plurality of processor cores can access a common memory structure. The access to the common memory structure can be accomplished through a coherent network-on-chip. The common memory can include on-chip memory, off-chip memory, etc. The coherent network-on-chip comprises a global coherency.

The system 800 can include a coupling component 830. The coupling component 830 can couple an evict buffer to the plurality of processor cores. The evict buffer is shared among the plurality of processor cores. As data is processed by the one or more processor cores, data within a cache such as a shared local cache can be updated and become “dirty”. The dirty data within the shared local cache differs from the data in a memory such as a shared system memory from which the data in the shared local cache was loaded. Thus, the data in the shared system memory must be updated to reflect the changes to the data in the shared local memory. Further, other local copies of the data from the shared system memory must be updated. However, the versions of the data in the shared system memory and the versions of the copies of the data in other shared local caches may still be required by other processes. Thus, data such as cache lines can be sent to the eject buffer prior to writing to storage such as shared system memory. In embodiments, the evict buffer enables delayed writes. The delayed writes can include writes initiated by a processor core to a local cache such as an L1 cache, writes to a shared L2 cache such as a hierarchical cache, writes to a shared system memory, and so on.

The system 800 can include a monitoring component 840. The monitoring component 840 can monitor evict buffer writes. Recall that the evict buffer writes can include writes associated with evicted cache lines such as dirty cache lines within a shared local cache. The monitoring evict buffer writes identifies a special cache coherency operation. The cache coherency operation can be associated with a cache maintenance operation such as a cache line zeroing operation, a cache line cleaning operation, a cache line flushing operation, a cache line invalidating operation, and so on. In embodiments, the special cache coherency operation that was identified can include a global snoop operation. A snoop operation can include notifying a memory system, hierarchical cache, other shared caches, etc. so that data such as a cache line has been modified. The snoop operation can include checking where there are other write requests that target a same address with storage such as the shared system memory. The snoop operation can include a global snoop operation. In embodiments, the global snoop operation can be initiated from an agent within a globally coherent system. The agent can include a process that intends to perform a write operation that changes a local copy of data in a local cache.

Recall that a snoop operation can be used to determine whether more than one operation needs to access a given address. The address can be present in a local cache associated with each of one or more cores, in a memory system, and so on. Since some operations such as a cache line operation can read contents of a cache line, modify a cache line, clear a cache line, etc., the order of the operations is critical to ensure correct processing of the cache line. A snoop operation can determine whether an address such as a load or a store address is present in one or more local caches, a hierarchical cache, etc. The snoop operation can be used to determine a proper order of execution of operations. Embodiments can include postponing a pending operation based on a snoop active field being set. A snoop active field being set can indicate that another snoop operation is being performed. Executing a pending operation could change data required by the operation that initiated the snoop operation. In other embodiments, the performing the cache line operation can be further based on one or more values in the snoop active field. The one or more values in the snoop active field can indicate a snoop precedence, a snoop priority, a snoop order, etc.

Discussed previously, in embodiments, the special cache coherency operation that was identified can include a cache maintenance operation (CMO). A cache maintenance operation can accomplish coherency of cache contents among local caches, a shared cache, system memory, and so on. In embodiments, the CMO can include a cache block operation (CBO) CLEAN instruction. A cache clean instruction can “clean” out dirty data. In embodiments, the special cache coherency operation that was identified can cause dirty data to be written into the evict buffer. The dirty data can be written from the evict buffer to memory such as the shared system memory at an appropriate time. The cache clean instruction can further clear any bit (e.g., “dirty bits”) that indicate that data is dirty from having been changed.

The system 800 can include a marking component 850. The marking component 850 can mark an evict buffer entry. The marking can be accomplished using one or more bits. The one or more bits can include a dirty bit, a duplicate write operation bit (discussed below), and so on. The marking can be based on a cache coherency operation. In embodiments, the marking corresponds to the special cache coherency operation that was identified. The special cache coherency operation that was identified can include a global snoop operation. The marking enables management of cache evict duplication. Cache evict duplication can occur when two or more write operations target the same address in memory. The memory can include a cache such as an intermediate cache, a shared system memory, etc. Further embodiments can include receiving an additional evict buffer write by the evict buffer. The additional evict buffer write can result from a cache block operation (CBO) such as a CLEAN instruction. The CBO CLEAN operation can be associated with dirty data in any of the shared caches, other caches, and so on. The additional evict buffer write can target a substantially similar address in memory or a different address. The target address of the additional evict buffer write can be compared to evict buffer writes already in the evict buffer.

Embodiments further include performing a fast compare between the additional evict buffer write and the evict buffer entry that was marked to detect duplication. Recall that a snoop operation can be initiated to indicate that a local copy of data such as data in a shared local cache has been changed. An evict buffer entry can be marked based on the snooping or on another cache management operation. In embodiments, the comparing can be based on a partial address of the evict buffer entry. The partial address can include a number of bits, a byte, and so on. In embodiments, the partial address can include a cache set index. The cache set index can be associated with a cache set present within the shared local cache. The fast compare can use the cache set index to determine whether the cache set that includes the target of the evict write operation is present in a local cache. The fast compare can determine whether there is a possible duplication. A possible duplication can require that the evict buffer writes be performed in a specified order in order to avoid a data race condition. Embodiments can further include an evict buffer write to a replay buffer, based on a duplication match in the fast compare. The replay buffer can be used to hold evict buffer writes while a determination is made as to whether the additional evict buffer write targets a duplicate address to a previously received evict buffer write. Noted previously, the evict buffer can be used to delay evict buffer writes. To determine whether two or more evict buffer writes target the same address, a more accurate comparison can be performed. Embodiments can further include performing a full compare between the additional evict buffer write that was sent to the replay buffer with the evict buffer entry that was marked. The fast compare and the full compare can be accomplished using logic. In embodiments, logic for the fast compare and the full compare can include shared logic.

The full compare can identify a duplication match or a duplication mismatch (i.e., no match). Embodiments can include marking, in the replay buffer, the operation that caused the additional evict buffer write, based on a duplication mismatch in the full compare. That is, the evict buffer write with which the additional evict buffer write was compared can access different locations. Thus, the operation that caused the additional evict buffer write can be retried or replayed. Embodiments can include replaying the operation that caused the additional evict buffer write, based on the duplication mismatch marking and a re-presentation of the additional evict buffer write from the replay buffer. The replaying can include retrying the operation that caused the additional evict buffer write. In a usage example, an additional evict buffer write is received. A fast compare is performed prior to sending the operation that caused the operation that caused the additional evict buffer write to the replay buffer. A full compare is performed on the additional evict buffer write. The operation that caused the additional evict buffer write is replayed, which could cause a fast compare to be performed based on the replay. Instead of performing a fast compare on the replayed evict buffer write, in embodiments, the re-presentation by the replay buffer can force an override of a subsequent fast compare. The subsequent fast compare can be overridden because a fast compare has already been performed and has produced a duplication mismatch.

The buffering of evict writes and the replaying of operation that caused the additional evict writes can maintain coherency within a compute coherency block (CCB). In addition to maintaining coherency with the CCB, coherency can be maintained between cores, cores and a hierarchical cache, a memory system such as a shared memory system, and so on. Embodiments can include supporting external coherency operations from outside the CCB and within the CCB. The external coherency operations can be associated with a cache, scratchpad memory, the memory system, etc. Embodiments can include a last level cache (LLC). The last level cache can hold data such as one or more cache lines. The cache lines can include modified cache lines that will update addresses in the memory system, addresses in other local caches, etc. The LLC can hold cache lines that update addresses in the hierarchical cache, local caches, and so on. In embodiments, the LLC can include a level two (L2) cache. The LLC can serve as an L2 cache to the hierarchal cache. The LLC can include a single level cache, a multilevel cache, and the like. Further embodiments can comprise a last-level cache (LLC) cache field in the cache line directory. The LLC cache field can be used to determine the state of a cache line in the LLC. The cache field can represent a state of a cache line in an encoded form. In embodiments, the LLC cache field bits can be defined as a ‘00’b indicating an invalid cache line, a ‘01’b indicating a shared cache line, a ‘10’b indicating an exclusive-clean cache line, and a ‘11’b indicating an exclusive-dirty cache line. The LLC cache field bits can be used to control the performing of an operation such as a cache line operation. In embodiments, the performing the cache line operation can be further based on values in the LLC cache field.

In embodiments, the cache line operation can include a cache maintenance operation. A cache maintenance operation can be performed to maintain cache coherency. The cache coherency maintenance can be applied to a local cache coupled to a core, a shared cache coupled to two or more processor cores, one or more local caches, a hierarchical cache, a last level cache, a common memory, a memory system, and so on. Various cache maintenance operations (CMOs) can be performed. In embodiments, the cache maintenance operation can include cache block operations. The cache block operations can include a subset of maintenance operations. The cache block operations can update a state associated with all caches such as the local caches. The updated state can include a specific state with respect to the hierarchical cache, the last level cache, the common memory, etc. In embodiments, the cache block operations can include a cache line zeroing operation, a cache line cleaning operation, a cache line flushing operation, and a cache line invalidating operation. The cache line operations can include making all copies of a cache line consistent with a cache line from the common memory while leaving the consistent copies in the local caches; flushing “dirty” data for a cache line then invalidating copies of the flushed, dirty data, and invalidating copies of a cache line without flushing dirty data to the common memory; and so on. In other embodiments, the cache line operation can include a coherent read operation. A coherent read operation can enable a read of data to be written to a memory address in a single cycle. That the new data can be read (e.g., a “flow through”) during an operation such as a read-during-write operation. In other embodiments, the coherent read operation can include a ReadShared operation and a ReadUnique operation.

A cache maintenance operation generates cache coherency transactions between global coherency and compute coherency blocks. The global coherency can include coherency between the common memory and local caches, among local caches, and so on. The local coherency can include coherency between a local cache and local processors coupled to the local cache. Maintaining the local cache coherency and the global coherency is complicated by the use of a plurality of local caches. Recall that a local cache can be coupled to a grouping of two or more processors. While the plurality of local caches can enhance operation processing by the groupings of processors, there can exist more than one dirty copy of one or more cache lines present in any given local cache. Thus, the maintaining of the coherency of the contents of the caches and the system memory can be carefully orchestrated to ensure that valid data is not overwritten, stale data is not used, etc. The cache maintenance operations can be enabled by an interconnect. In embodiments, the grouping of two or more processor cores and the shared local cache can be interconnected to the grouping of two or more additional processor cores and the shared additional local cache using the coherent network-on-chip. In embodiments, the system 800 implements cache management through implementation of semiconductor logic. One or more processors can execute instructions which are stored to generate semiconductor logic to: access a plurality of processor cores, wherein each processor of the plurality of processor cores accesses a common memory through a coherent network-on-chip, and wherein the coherent network-on-chip comprises a global coherency; couple a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and perform a cache maintenance operation in the grouping of two or more processor cores and the shared local cache, wherein the cache maintenance operation generates cache coherency transactions between the global coherency and the local coherency.

The transferring between a compute coherency block cache (CCB$) and a bus interface unit can compensate for mismatches in bit widths, transfer rates, access times, etc. between the CCB$ and the bus interface unit. In embodiments, cache lines can be stored in a bus interface unit cache prior to commitment to the common memory structure. Once transferred to the BIU, the BIU can handle the transferring of cache lines such as evicted cache lines to the common memory based on the snoop responses. The transferring can include transferring the cache line incrementally or as a whole. The snoop responses can be used to determine an order in which the cache lines can be committed to the common memory. In other embodiments, cache lines can be stored in a bus interface unit cache pending a cache line fill from the common memory structure. The cache lines can be fetched incrementally or as a whole from the common memory and stored in the BIU cache. In other embodiments the ordering and the mapping can include a common ordering point for coherency management. The common ordering point can enable coherency management between a local cache and processor cores coupled to the local cache, between local caches, between local caches and the common memory, and the like. In further embodiments, the common ordering point can include a compute coherency block coupled to the plurality of processor cores. The compute coherency block can be colocated with the processor cores within an integrated circuit, located within one or more further integrated circuits, etc.

The system 800 can include a computer program product embodied in a non-transitory computer readable medium for cache management, the computer program product comprising code which causes one or more processors to generate semiconductor logic for: accessing a plurality of processor cores, wherein each processor of the plurality of processor cores includes a shared local cache, and wherein the plurality of processor cores implements special cache coherency operations; coupling an evict buffer to the plurality of processor cores, wherein the evict buffer is shared among the plurality of processor cores, and wherein the evict buffer enables delayed writes; monitoring evict buffer writes, wherein the monitoring evict buffer writes identifies a special cache coherency operation; and marking an evict buffer entry, wherein the marking corresponds to the special cache coherency operation that was identified, and wherein the marking enables management of cache evict duplication.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Disclosed embodiments are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for cache management comprising:
accessing a plurality of processor cores, wherein each processor of the plurality of processor cores includes a shared local cache, and wherein the plurality of processor cores implements special cache coherency operations;
coupling an evict buffer to the plurality of processor cores, wherein the evict buffer is shared among the plurality of processor cores, and wherein the evict buffer enables delayed writes;
monitoring evict buffer writes, wherein the monitoring evict buffer writes identifies a special cache coherency operation; and
marking an evict buffer entry, wherein the marking corresponds to the special cache coherency operation that was identified, and wherein the marking enables management of cache evict duplication.

2. The method of claim 1 wherein the special cache coherency operation that was identified comprises a global snoop operation.

3. The method of claim 2 wherein the global snoop operation is initiated from an agent within a globally coherent system.

4. The method of claim 1 wherein the special cache coherency operation that was identified comprises a cache maintenance operation (CMO).

5. The method of claim 4 wherein the CMO comprises a cache block operation (CBO) CLEAN instruction.

6. The method of claim 1 wherein the special cache coherency operation that was identified causes dirty data to be written into the evict buffer.

7. The method of claim 1 further comprising receiving an additional evict buffer write by the evict buffer.

8. The method of claim 7 further comprising performing a fast compare between the additional evict buffer write and the evict buffer entry that was marked to detect duplication.

9. The method of claim 8 wherein the comparing is based on a partial address of the evict buffer entry.

10. The method of claim 9 wherein the partial address comprises a cache set index.

11. The method of claim 8 further comprising sending the operation that caused the additional evict buffer write to a replay buffer, based on a duplication match in the fast compare.

12. The method of claim 11 further comprising performing a full compare between the additional evict buffer write with the evict buffer entry that was marked.

13. The method of claim 12 wherein logic for the fast compare and the full compare comprises shared logic.

14. The method of claim 12 further comprising marking, in the replay buffer, the operation that caused the additional evict buffer write, based on a duplication mismatch in the full compare.

15. The method of claim 14 further comprising replaying the operation that caused the additional evict buffer write, based on the duplication mismatch marking and a re-presentation of the operation that caused the additional evict buffer write from the replay buffer.

16. The method of claim 15 wherein the re-presentation by the replay buffer forces an override of a subsequent fast compare.

17. The method of claim 1 wherein the shared local cache is coupled to a grouping of two or more processor cores of the plurality of processor cores.

18. The method of claim 17 wherein the shared local cache is shared among the two or more processor cores.

19. The method of claim 18 wherein the grouping of two or more processor cores and the shared local cache operates using local coherency.

20. The method of claim 19 wherein the local coherency is distinct from a global coherency.

21. The method of claim 20 further comprising performing a cache maintenance operation in the grouping of two or more processor cores and the shared local cache.

22. The method of claim 21 wherein the cache maintenance operation generates cache coherency transactions between the global coherency and the local coherency.

23. The method of claim 20 further comprising performing a global snoop operation on the shared local cache.

24. A computer program product embodied in a non-transitory computer readable medium for cache management, the computer program product comprising code which causes one or more processors to generate semiconductor logic for:
accessing a plurality of processor cores, wherein each processor of the plurality of processor cores includes a shared local cache, and wherein the plurality of processor cores implements special cache coherency operations;
coupling an evict buffer to the plurality of processor cores, wherein the evict buffer is shared among the plurality of processor cores, and wherein the evict buffer enables delayed writes;
monitoring evict buffer writes, wherein the monitoring evict buffer writes identifies a special cache coherency operation; and
marking an evict buffer entry, wherein the marking corresponds to the special cache coherency operation that was identified, and wherein the marking enables management of cache evict duplication.

25. A computer system for cache management comprising:
a memory which stores instructions;
one or more processors coupled to the memory wherein the one or more processors, when executing the instructions which are stored, are configured to:
access a plurality of processor cores, wherein each processor of the plurality of processor cores includes a shared local cache, and wherein the plurality of processor cores implements special cache coherency operations;
couple an evict buffer to the plurality of processor cores, wherein the evict buffer is shared among the plurality of processor cores, and wherein the evict buffer enables delayed writes;
monitor evict buffer writes, wherein the monitoring evict buffer writes identifies a special cache coherency operation; and
mark an evict buffer entry, wherein the marking corresponds to the special cache coherency operation that was identified, and wherein the marking enables management of cache evict duplication.
